(19) United States
(12) Patent Application Publication
(10) Pub. No.: US 2006/0273962 A1
(43) Pub. Date: Dec. 7, 2006

(54) Rack mounted directional antenna

(76) Inventor: Colin E. Brench, Allen, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/143,904

(22) Filed: Jun. 2, 2005

(51) Int. Cl. H01Q 1/24

(52) U.S. Cl. 343/702

(57) ABSTRACT

A computer rack comprises a support structure operable to engage a plurality of computer systems. An enclosure substantially surrounds the support structure. An antenna is mounted to an outer surface of said enclosure.

### BACKGROUND

Many computer systems and components, such as servers, routers, and storage arrays, are configured for mounting in rack enclosures that allow for efficient storage of multiple components. Many rack enclosures are essentially large cabinets into which a plurality of components are mounted. These racks are often designed for densely storing a multitude of components while allowing for easy access to the components for upgrading and maintenance. It is not unusual to find a number of racks co-located in a sever farm, or other large grouping of components.

Wireless communication is utilized by a variety of devices including cellular phones, pagers, and wireless networks. Reliable operation of wireless systems depends on proper design and placement of antennas for transmitting and receiving the wireless signals. Wireless signals are generally high-frequency, short wavelength radio signals. Wireless signals can interfere with the normal operation of certain electronic components. This interference may be of particular concern in large server farms where it is not uncommon to have individual components being serviced while the overall system remains in operation. Once an individual component is opened for service, its electromagnetically sensitive equipment may be exposed to wireless signals from wireless equipment, such as cellular phones, pagers, and other portable devices. The preferred embodiments of the present invention described below overcome these and other deficiencies of the prior art while focusing on these needs.

### SUMMARY

A computer rack comprises a support structure operable to engage a plurality of computer systems. An enclosure substantially surrounds the support structure. A directional antenna is mounted to an outer surface of said enclosure.

### BRIEF DESCRIPTION OF THE DRAWINGS

For a detailed description of exemplary embodiments of the invention, reference will now be made to the accompanying drawings in which:

FIG. 1 illustrates a server rack constructed in accordance with embodiments of the invention; and

FIG. 2 illustrates a server rack constructed in accordance with embodiments of the invention.

### DETAILED DESCRIPTION

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

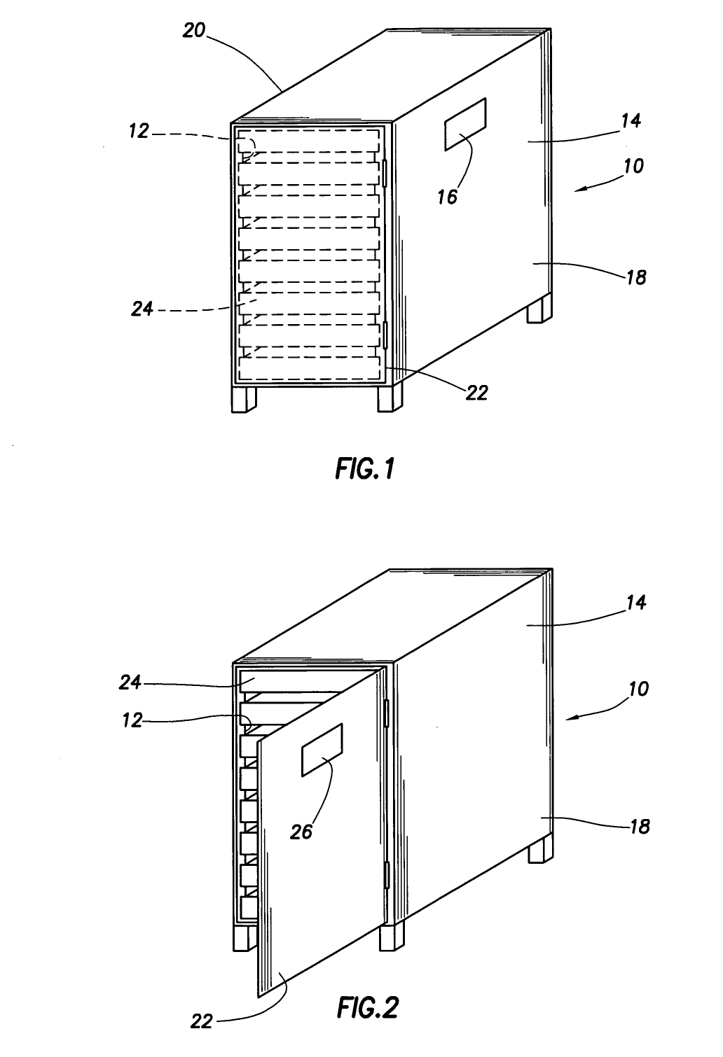

Referring to FIG. 1, computer rack 10 comprises support structure 12, enclosure 14, and antenna 16. Enclosure 14 substantially surrounds structure 12 and comprises opposed side panels 18 and 20 as well as door 22. A plurality of rack-mountable computer components 24 are engaged with and supported by support structure 12 within enclosure 14. Antenna 16 may be electrically coupled to at least one of computer components 24, such as a relay, router, or computer system.

As shown in FIG. 1, antenna 16 is a flat panel antenna and is integrated into side panel 18. Antenna 16 can be positioned in any desired location on side panel 18. For example, antenna 16 may be positioned so as to minimize interference with sensitive cable connections or other components. Antenna 16 may be integrated into side panel 18 such that the outer surface of the antenna is co-planar with the outer surface of the panel. In some embodiments, the antenna and panel are integrated such that the overall thickness of the panel does not increase and the combination antenna and panel takes up no more space than a conventional panel without an integrated antenna. Side panel 18 may also comprise features that shield the interior of enclosure 14 from the field generated by antenna 16.

Referring now to FIG. 2, enclosure 14 may comprise antenna 26 mounted to door 22. Antenna 26 may be in addition to, or as an alternative to, the side-panel mounted antenna of FIG. 1. Antenna 26 is coupled to at least one of components 24, such as by a cable or some other connection. In certain embodiments, antenna 26 may be coupled to a router, relay, or other communication component that is independent of the other components within enclosure 14.

Antenna 26 may be integrated into door 22 such that the outer surface of the antenna is co-planar with the outer surface of the door. In some embodiments, the overall thickness of the door and antenna is such that the combination antenna and door is the same thickness as a conventional door without an integrated antenna. Because door 22 is hinged to enclosure 14, mounting antenna 26 to door 22 provides the added advantage of moving the antenna away from components 24 when the door is opened. Door 22 may also comprise features that shield the interior of enclosure 14 from the field generated by antenna 26.

Both door 22 and side panels 18 and 20 may comprise one or more integral antennas. The antennas can be placed in any desirable location on the enclosure. For example, antennas may be placed to minimize the interference with sensitive components or could be placed so as to improve communication with a cooperating antenna on another component. Further, placing an antenna on an outside surface of a rack enclosure allows a well defined, stable location of the antenna. This permits the determination of radiation patterns developed by the antenna, which can then be controlled or managed in order to decrease interference with sensitive components.

The antennas described herein may be a flat-panel antenna, directional antenna, dipole antenna, or any type of antenna suited for use with wireless network systems. The communications protocols for these systems are common industry standards and generally use high-frequency, short wavelength signals. Because of the short wavelength signals used, the size of the antennas can be minimized, especially when the position and orientation of the antenna can be closely controlled.

The above discussion is meant to be illustrative of the principles and various embodiments of the present invention. Numerous variations and modifications will become apparent to those skilled in the art once the above disclosure is fully appreciated. For example, many configurations and types of antennas could be integrated into a variety of rack enclosures. It is intended that the following claims be interpreted to embrace all such variations and modifications.

What is claimed is:

1. A computer rack comprising:
a support structure operable to engage a plurality of computer systems;
an enclosure substantially surrounding said support structure; and
an antenna mounted to an outer surface of said enclosure.

2. The computer rack of claim 1 wherein said antenna is a high frequency antenna.

3. The computer rack of claim 1 wherein said antenna is electrically coupled to the computer systems within said support structure.

4. The computer rack of claim 1 wherein said enclosure comprises two opposing sides and a door.

5. The computer rack of claim 4 wherein said antenna is mounted on one of the opposing sides.

6. The computer rack of claim 4 wherein said antenna is a flat panel antenna integrated into one of the opposing sides.

7. The computer rack of claim 4 wherein said antenna is mounted on the door.

8. The computer rack of claim 4 wherein said antenna is a flat panel antenna integrated into the door.

9. The computer rack of claim 1 wherein said enclosure shields the plurality of computer systems from a field generated by said antenna.

10. A computer system comprising:
a rack enclosure;
a plurality of computer components disposed within said rack enclosure;
an antenna disposed on an outer surface of said rack enclosure and coupled to at least one of said plurality of computer components.

11. The computer system of claim 10 wherein said antenna is a high frequency antenna.

12. The computer system of claim 10 wherein said antenna is mounted to a side of said rack enclosure.

13. The computer system of claim 12 wherein said antenna has a front surface that is co-planar with an outer surface of the side of said rack enclosure.

14. The computer system of claim 10 wherein said antenna is mounted to a door of said rack enclosure.

15. The computer system of claim 14 wherein said antenna has a front surface that is co-planar with an outer surface of the door of said rack enclosure.

16. The computer system of claim 10 wherein said plurality of computer components comprises server systems.

17. The computer system of claim 10 wherein said rack enclosure shields said plurality computer components from said antenna.

18. A server rack comprising:
a support structure operable to engage a plurality of server systems;
an enclosure substantially surrounding said support structure; and
means for transmitting and receiving wireless signals, wherein said means is integrated into said enclosure.

19. The server rack of claim 18 wherein said means for transmitting and receiving is integrated into a side of said enclosure.

20. The server rack of claim 18 wherein said means for transmitting and receiving is integrated into a door of said enclosure.
